(19) United States
(12) Patent Application Publication
(10) Pub. No.: US 2024/0182283 A1
(43) Pub. Date: Jun. 6, 2024

(54) SYSTEMS AND METHODS FOR MATERIAL FLOW AUTOMATION

(71) Applicant: Seegrid Corporation, Pittsburgh, PA (US)

(72) Inventors: Andy Christman, Pittsburgh, PA (US); Andrew DiFurio, Pittsburgh, PA (US); Francine Gemperle, Pittsburgh, PA (US); Atticus Huberts, Pittsburgh, PA (US); Tri-An Le, Pittsburgh, PA (US); Jesse Legg, Pittsburgh, PA (US); Craig Pentrak, Pennsylvania, PA (US); Stephen Ramusivich, McMurray, PA (US)

(21) Appl. No.: 18/527,669

(22) Filed: Dec. 4, 2023

Related U.S. Application Data
(60) Provisional application No. 63/430,182, filed on Dec. 5, 2022.

(51) Int. Cl. B66F 9/06; B66F 9/075

(52) U.S. Cl. CPC B66F 9/063; B66F 9/0755

(57) ABSTRACT

A system and method are provided for a material flow automation process. In some embodiments, the system and/or method comprise: receiving a first input including a plurality of core material flow elements; receiving a second input including a variable parameter that includes a status of each of the core material flow elements; applying the parameter to the plurality of core material flow elements; determining a plurality of composable material flow logic patterns from the application of the variable parameter to the plurality of core material flow elements; and applying the composable material flow logic patterns for managing an automation of movement of a vehicle.

### CROSS REFERENCE TO RELATED APPLICATIONS

This application claims priority to 63/430,182 filed on Dec. 5, 2022, entitled Composable Patterns of Material Flow Logic for the Automation of Movement, the contents of which are incorporated herein by reference in their entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); International Application No.: PCT/US23/033818, filed on Sep. 27, 2023, entitled Shared Resource Management System and Method; International Application No.: PCT/US23/079141, filed on Nov. 8, 2023, entitled System And Method For Definition Of A Zone Of Dynamic Behavior With A Continuum Of Possible Actins and Locations Within Same; International Application No.: PCT/US23/078890, filed on Nov. 7, 2023, entitled Method And System For Calibrating A Light-Curtain; International Application No.: PCT/US23/036650, filed on Nov. 2, 2023, entitled System and Method for Optimized Traffic Flow Through Intersections with Conditional Convoying Based on Path Network Analysis; U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System That Handles Uncertainty with Human and Logic Collaboration in A Material Flow Automation Solution; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Pat. No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent appl. Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number 2023/0376030, Published on Nov. 23, 2023, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and material flow planning that includes the use of autonomous mobile robots (AMRs) for material handling. In particular, the inventive concepts may be related to systems and methods that implement composable patterns of material flow logic for the automation of movement in a complex environment to maximize speed and quality of application development.

### BACKGROUND

Within increasing numbers and types of environments autonomous vehicles may travel through areas and/or along pathways that are shared with other vehicles and/or pedestrians. Such other vehicles can include other autonomous vehicles, semi-autonomous vehicles, and/or manually operated vehicles. The autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation. Herein, vehicles that are configured for autonomous navigation are referred to as AMRs.

Multiple AMRs may have access to an environment and both the state of the environment and the state of an AMR are constantly changing. The environment can be within, for example, a warehouse or large storage space or facility and the AMRs can include, but are not limited to, pallet lifts, pallet trucks, and tuggers.

Industrial AMRs need to use industrial controllers, that is, programmable logic controllers (PLCs), to achieve a higher level of automation. In order to fully leverage PLCs in industrial automation, they need to be integrated with a fleet management software. When enabling the integration, the integration can be done directly and specifically, or more generally. To enable more industrial automation use cases, a generalized approach is required to abstract integration between industrial controllers and AMRs.

Conventional material flow planning for indoor operations treats each indoor facility, e.g., warehouse, etc., as having a unique space where the material flow such as the storage, packaging and movement of goods has distinct problems and requires a unique plan. However, in order to implement a unique or bespoke flow solution, considerable time and resources are required and expensive to implement. In addition, conventional bespoke material flow automation designs cannot be replicated, and therefore reduce efficiencies. After each solution is designed by application developers, a series of complex decision-based proprietary rules are created for the individual application. Accordingly, material flow automation solutions are formed on a case-by-case and non-repeatable basis.

### SUMMARY

In accordance with various aspects of the inventive concepts, provided is a method for material flow automation process, comprising: receiving a first input including a plurality of core material flow elements; receiving a second input including a variable parameter that includes a status of each of the core material flow elements; applying the parameter to the plurality of core material flow elements; determining a plurality of composable material flow logic patterns from the application of the variable parameter to the plurality of core material flow elements; and applying the composable material flow logic patterns for managing an automation of movement of a vehicle.

In various embodiments, the core material flow elements include data regarding a pick, drop, location, and route of the vehicle.

In various embodiments, the vehicle is an autonomous mobile robot (AMR).

In various embodiments the key variable includes a status of whether the core material flow elements are known or unknown.

In various embodiments, the core material flow elements and the variable parameter are arranged as a pattern language for determining the composable material flow logic patterns, and the method further comprises modeling a material flow for repeatable patterns of movement by the vehicle according to the pattern language.

In various embodiments, the pattern language is based on at least one indoor flow pattern of a factory or warehouse.

In various embodiments, the pattern language includes a collection of workflow templates for material movement which are used for determining a material workflow based on one or more combinations of the core material flow elements.

In various embodiments, applying the composable material flow logic patterns includes dynamically selecting one of a plurality of possible routes when a route is unknown, the one of the possible routes including a combination of the plurality of core material flow elements.

In accordance with various aspects of the inventive concepts, provided is a computer readable medium having computer executable instructions for a material flow planning system that when executed by a processor performs the following steps comprising: receiving at first input of the material flow planning system including a plurality of core material flow elements; receiving a second input of the material flow planning system including a variable parameter that includes a status of each of the core material flow elements; applying the parameter to the plurality of core material flow elements; determining a plurality of composable material flow logic patterns from the application of the variable parameter to the plurality of core material flow elements; and applying the composable material flow logic patterns for managing an automation of movement of a vehicle.

In various embodiments, the core material flow elements include data regarding a pick, drop, location, and route of the vehicle.

In various embodiments, the vehicle is an autonomous mobile robot (AMR).

In various embodiments the key variable includes a status of whether the core material flow elements are known or unknown.

In various embodiments, the core material flow elements and the variable parameter are arranged as a pattern language for determining the composable material flow logic patterns, and the method further comprises modeling a material flow for repeatable patterns of movement by the vehicle according to the pattern language.

In various embodiments, the pattern language is based on at least one indoor flow pattern of a factory or warehouse.

In various embodiments, the pattern language includes a collection of workflow templates for material movement which are used for determining a material workflow based on one or more combinations of the core material flow elements.

In various embodiments, applying the composable material flow logic patterns includes dynamically selecting one of a plurality of possible routes when a route is unknown, the one of the possible routes including a combination of the plurality of core material flow elements.

In accordance with various aspects of the inventive concepts, provided is a pattern language for use in modeling a material flow, comprising: four core material flow elements, including pick data, drop data, location data, and route data of a material flow machine; and a variable parameter including a status of at least one of the four core material flow elements.

In various embodiments, the pattern language determines one or more composable material flow logic patterns, and a material flow for repeatable patterns of movement by a vehicle is determined according to the pattern language.

In various embodiments, the pattern language is based on at least one indoor flow pattern of a factory or warehouse.

In various embodiments, the pattern language includes a collection of workflow templates for material movement which are used for determining a material workflow based on one or more combinations of the core material flow elements.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of an AMR lift truck that comprises an embodiment of the systems described herein, in accordance with aspects of the inventive concepts.

FIG. 2 is a block diagram of an AMR, in accordance with aspects of the inventive concepts.

FIG. 3 illustrates an example of a warehouse environment in which embodiments of the present inventive concepts can be practiced.

FIG. 4 is a flow diagram of a material flow automation process, in accordance with aspects of inventive concepts.

FIG. 5 is a block diagram of a system for implementing patterns of material flow logic, in accordance with some embodiments.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspect of the inventive concepts, to enable a flexible system for implementing composable and repeatable patterns of material flow logic for a plurality of material flow automation solutions, a system and method are provided that leverage a pattern language comprising a combination of a set of core material flow elements, namely, pick, drop, location, and route and a key variable based on a known and unknown status on the elements. For example, details on destination locations and path plans may not be known in advance, for example, before a robot such as an AMR performs a pick or drop operation. Although an AMR may be trained to operate along a given route, multiple originating and/or destination locations may be available so an operator may desire for the AMR to dynamically determine a route. A plurality of repeatable patterns of a material flow can be established from the pattern language. The core material elements existing in known and unknown states allows a special-purpose computer to perform route planning and simulation, modeling, analytics, and so on and to accommodate a considerable number, e.g., thousands, of likely material flow scenarios from a user interface.

In order for the AMR to perform a pick or drop operation, in some embodiments, an AMR may interface with an industrial infrastructure to pick and drop pallets. In order for an AMR to accomplish this, its perception and manipulation systems in accordance with principles of inventive concepts may maintain a model for what a pallet is, as well as models for all the types of infrastructure for which it will place the pallet (e.g., tables, carts, racks, conveyors, etc.). These models are software components that are parameterized in a way to influence the algorithmic logic of the computation.

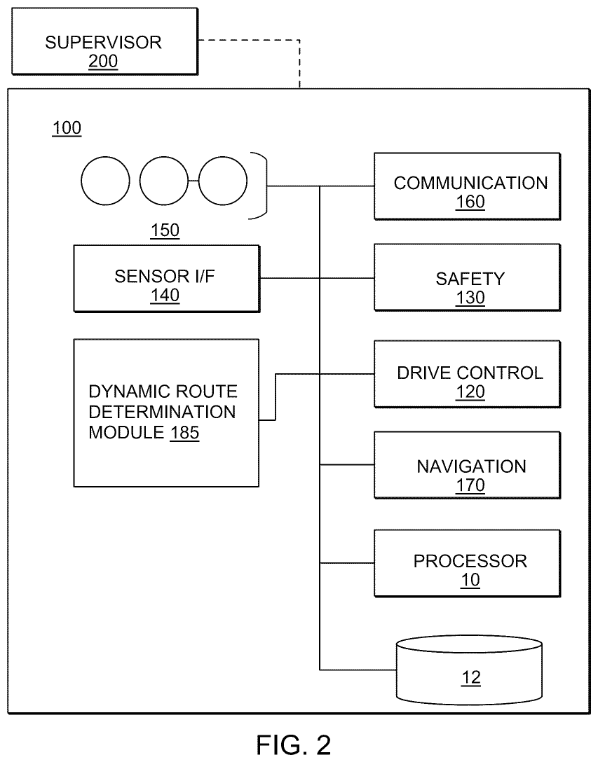

In example embodiments a route network may be constructed by an operator through training-by-demonstration, wherein an operator leads the AMR through a training route and inputs behaviors (for example, picks or places) along the route. A build procedure employs information gathered during training (for example, odometry, grid information including localization information, and operator input regarding behaviors) into a route network. An AMR may then employ the route network to autonomously follow during normal operation. The route network may be modeled, or viewed, as a graph of nodes and edges, with stations as nodes and trained segments as edges. Behaviors may be trained within segments. Behaviors may include “point behaviors” such as picks and drops or “zone behaviors” such as intersections. In example embodiments an AMR's repetition during normal operations of a trained route may be referred to as a “follow.” Anything, other than the follow itself, the AMR does during the follow may be viewed as a behavior. Zones such as intersections may include behaviors that are performed before, during, and/or after the zone. For intersections, the AMR requests access to the intersection from a supervisory system, also referred to herein as a supervisor or supervisory processor, (for example, Supervisor™ described elsewhere herein), e.g., shown in FIG. 2, prior to reaching the area covered by the intersection zone. When the AMR exits the zone, it releases that access to the supervisory system.

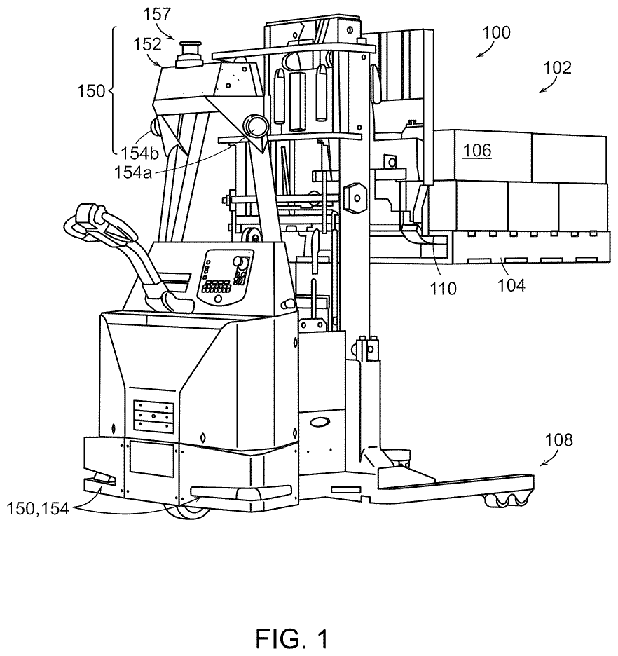

Referring to FIGS. 1 and 2, shown is an example of a self-driving or robotic vehicle in the form of an AMR lift truck 100 that is equipped and configured to drop off and pick up objects, such as palletized loads or other loads, in accordance with aspects of the inventive concepts. Although the robotic vehicle can take the form of an AMR lift truck 100, the inventive concepts could be embodied in any of a variety of other types of robotic vehicles and AMRs, including, but not limited to, forklifts, tow tractors, tuggers, and the like.

In this embodiment, AMR 100 includes a payload area 102 configured to transport any of a variety of types of objects that can be lifted and carried by a pair of forks 110. Such objects can include a pallet 104 loaded with goods 106, collectively a “palletized load,” or a cage or other container with fork pockets, as examples. Outriggers 108 extend from the robotic vehicle 100 in the direction of forks 110 to stabilize the AMR, particularly when carrying palletized load 104, 106.

Forks 110 may be supported by one or more robotically controlled actuators coupled to a carriage that enable AMR 100 to raise and lower, side-shift, and extend and retract to pick up and drop off objects in the form of payloads, e.g., palletized loads 104 or other loads to be transported by the AMR. In various embodiments, the AMR may be configured to robotically control the yaw, pitch, and/or roll of forks 110 to pick a palletized load in view of the pose of the load and/or horizontal surface that supports the load. In various embodiments, the AMR may be configured to robotically control the yaw, pitch, and/or roll of forks 110 to pick a palletized load in view of the pose of the horizontal surface that is to receive the load.

The AMR 100 may include a plurality of sensors 150 that provide various forms of sensor data that enable the AMR to safely navigate throughout an environment, engage with objects to be transported, and avoid obstructions. In various embodiments, the sensor data from one or more of sensors 150 can be used for path navigation and obstruction detection and avoidance, including avoidance of detected objects, hazards, humans, other robotic vehicles, and/or congestion during navigation.

One or more of sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in a 3D model and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

Sensors 150 can include one or more stereo cameras 152 and/or other volumetric sensors, sonar sensors, radars, and/or LiDAR scanners or sensors 154a, 154b positioned about AMR 100, as examples. Inventive concepts are not limited to particular types of sensors, nor the types, configurations, and placement of the AMR sensors in FIGS. 1 and 2. In some embodiments, object movement techniques (i.e., dropping an object in the zone, removing an object from a zone) described herein are performed with respect to one or more of sensors 150, in particular, a combination of object detection sensors and load presence sensors. The object detection sensor(s) is/(are) configured to locate a position of an object within the zone. An object detection sensor can be or include at least one camera, LiDAR, electromechanical, and so on. The load presence sensor(s) is/(are) configured to determine whether AMR 100 is carrying an object.

In the embodiment shown in FIG. 1, at least one of LiDAR devices 154a,b can be a 2D or 3D LiDAR device for performing safety-rated forward obstruction sensing functions. In alternative embodiments, a different number of 2D or 3D LiDAR devices are positioned near the top of AMR 100. Also, in this embodiment a LiDAR 157 is located at the top of the mast. In some embodiments LiDAR 157 is a 2D LiDAR used for localization or odometry-related operations.

The object detection and load presence sensors can be used in combination with others of the sensors, e.g., stereo camera head 152. Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

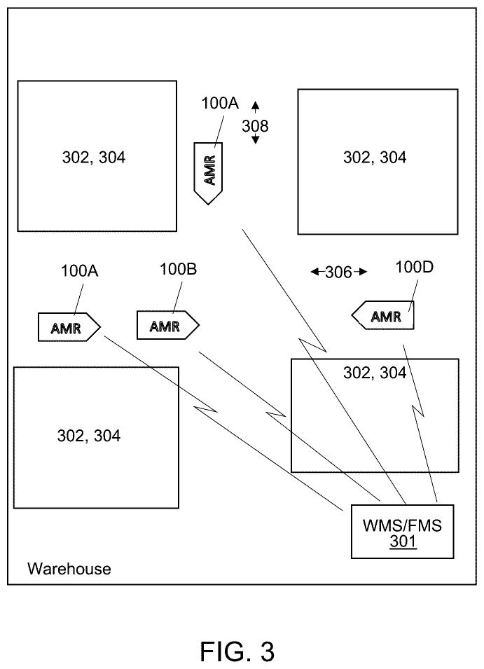

FIG. 3 is a block diagram of components of an embodiment of AMR 100 of FIG. 1, incorporating technology for moving and/or transporting objects (e.g., loads or pallets) to/from a predefined zone, in accordance with principles of inventive concepts. In the example embodiment shown in FIGS. 1 and 2, AMR 100 is a warehouse robotic vehicle, which can interface and exchange information with one or more external systems, including a supervisor system, fleet management system, and/or warehouse management system (collectively “supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to AMR 100, and to monitor the navigation and activity of the AMR and, optionally, other AMRs. The AMR can include a communication module 160 configured to enable communications with supervisor 200 and/or any other external systems. Communication module 160 can include hardware, software, firmware, receivers, and transmitters that enable communication with supervisor 200 and any other external systems over any now known or hereafter developed communication technology, such as various types of wireless technology including, but not limited to, Wi-Fi, Bluetooth™, cellular, global positioning system (GPS), radio frequency (RF), and so on.

As an example, supervisor 200 could wirelessly communicate a path for AMR 100 to navigate for the vehicle to perform a task or series of tasks. The path can be a virtual line that the AMR is following during autonomous motion. The path can be relative to a map of the environment stored in memory and, optionally, updated from time-to-time, e.g., in real-time, from vehicle sensor data collected in real-time as AMR 100 navigates and/or performs its tasks. The sensor data can include sensor data from one or more sensors described with reference to FIG. 1. As an example, in a warehouse setting the route could include a plurality of stops along a route for the picking and loading and/or the unloading of objects, e.g., payload of goods. The route can include a plurality of path segments, including a zone for the acquisition or deposition of objects. Supervisor 200 can also monitor AMR 100, such as to determine the AMR's location within the environment, battery status and/or fuel level, and/or other operating, vehicle, performance, and/or load parameters.

As described above, when training an AMR 100, a route may be developed. That is, an operator may guide AMR 100 through a travel path within the environment while the AMR, through a machine-learning process, learns and stores the route for use in task performance and builds and/or updates an electronic map of the environment as it navigates, with the route being defined relative to the electronic map. The route may be stored for future use and may be updated, for example, to include more, less, or various locations, or to otherwise revise the travel route and/or path segments, as examples.

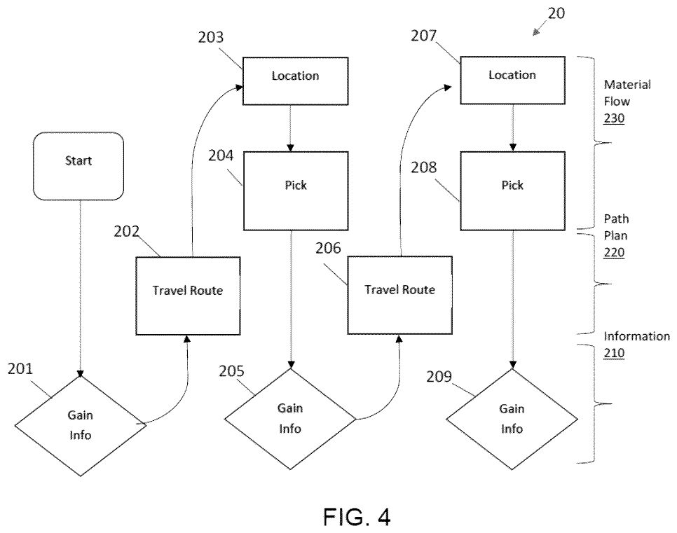

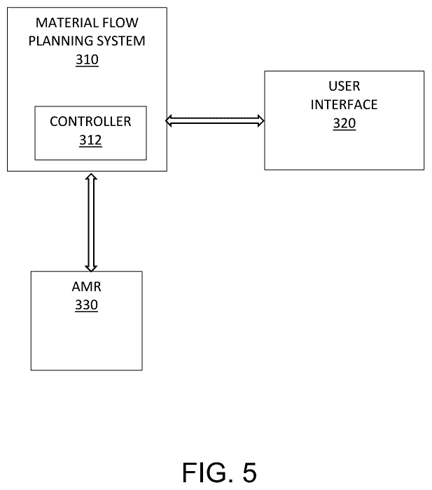

As is shown in FIG. 2, in example embodiments, AMR 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment. In some embodiments, memory 12 stores relevant measurement data for use by a dynamic route determination module 185. In some embodiments, the dynamic route determination module 185 is part of a controller, for example, industrial controller 312 described with respect to FIG. 5. In some embodiments, the dynamic route determination module 185 includes a processor and memory for performing some or all of the material flow automation process 20 of FIG. 4.

In this embodiment, processor 10 and memory 12 are shown onboard AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of AMR 100 can further include a navigation module 170 configured to access environmental data, such as the electronic map, and path information stored in memory 12, as examples. Navigation module 170 can communicate instructions to a drive control subsystem 120 to cause AMR 100 to navigate its route by navigating a path within the environment. During vehicle travel, navigation module 170 may receive information from one or more sensors 150, via a sensor interface (I/F) 140, to control and adjust the navigation of the AMR. For example, sensors 150 may provide 2D and/or 3D sensor data to navigation module 170 and/or drive control subsystem 120 in response to sensed objects and/or conditions in the environment to control and/or alter the AMR's navigation. As examples, sensors 150 can be configured to collect sensor data related to objects, obstructions, equipment, goods to be picked, hazards, completion of a task, and/or presence of humans and/or other robotic vehicles. An object can be a pickable or non-pickable object within a zone used by the vehicle, such as a palletized load, a cage with slots for forks at the bottom, a container with slots for forks located near the bottom and at the center of gravity for the load. Other objects can include physical obstructions in a zone such as a traffic cone or pylon, a person, and so on.

A safety module 130 can also make use of sensor data from one or more of sensors 150, in particular, LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

As shown in FIGS. 1 and 2, in various embodiments, the system can comprise a mobile robotics platform, such as an AMR, at least one sensor 150 configured to collect/acquire point cloud data, such as a LiDAR scanner or 3D camera; and at least one local processor 10 configured to process, interpret, and register the sensor data relative to a common coordinate frame. For example, scans from the sensor 150, e.g., LiDAR scanner or 3D camera, are translated and rotated in all six degrees of freedom to align to one another and create a contiguous point cloud. To do this, a transform is applied to the data. The sensor data collected by sensors 150 can represent objects using the point clouds, where points in a point cloud represent discrete samples of the positions of the objects in 3-dimensional space. AMR 100 may respond in various ways depending upon whether a point cloud based on the sensor data includes one or more points impinging upon, falling within an envelope of, or coincident with the 3-dimensional path projection (or tunnel) of AMR 100.

FIG. 3 illustrates an example of a warehouse environment in which embodiments of the present inventive concepts can be practiced. In example embodiments, a material flow system in accordance with principles of the inventive concepts may be implemented in a facility such as a manufacturing, processing, or warehouse facility, for example. For brevity and clarity of description the example embodiments described herein will generally be in reference to warehouse implementations, but inventive concepts are not limited thereto.

In the example embodiment of FIG. 3, items (not shown) can be stored in storage racks 302 distributed throughout a warehouse. Storage racks 302 may be divided into bays 304 and bays 304 may be further divided into shelves (not shown). Racks 302 may be configured to store items within bins, on any of a variety of pallets, or other materials handling storage units. The racks 302 may be single- or multi-level, for example, and may vary in width, length, and height. Staging areas (not shown) may be used to temporarily store items for shipping or receiving, respectively, to/from transportation means, such as truck or train for example, to external facilities. Rows 306 and aisles 308 provide access to storage racks 302.

As shown, a plurality of vehicles such as AMRs 100A-100D (generally, 100) can be in communication with a fleet management system (FMS) and/or warehouse management system (WMS) 302, in accordance with aspects of inventive concepts. One or more user interfaces, for example, user interface 320 shown in FIG. 5, may be distributed throughout the warehouse. The user interfaces may be employed by an operator to interact with a system such as one described in the discussion related to FIG. 2 to direct a vehicle to pick an item from one location (a specific storage rack, for example) and to place it in another location (a staging area, for example). The user interfaces may be included within AMRs, may be in standalone screens or kiosks positioned throughout the warehouse, may be handheld electronic devices, or may be implemented as applications on smartphones or tablets, for example. One or more humans (not shown) may also work within the environment and communicate with the WMS 301, for example, via a user interface. The humans and the AMRs 100 can also communicate directly, in some embodiments. In some embodiments, the humans can order pickers that load goods on AMRs at pick locations within the warehouse environment. The humans may employ handheld electronic devices through which they can communicate with the WMS and/or the AMRs.

The AMRs 100 can operate according to route, destination, and robotic actions determined by embodiments of the systems and methods herein. For example, an AMR 100 may travel along a first predetermined route, for example, according to the process described in FIG. 4, and in doing so can use its cameras, sensors, processors, and autonomous technology, e.g., shown in FIGS. 1 and 2, to collect information that can be used for a subsequent pick or drop, which may be unknown while a location of the subsequent pick or drop is known. A material flow planning system may be implemented in the WMS/FMS 301 or implemented as part of an automation system in communication with the WMS/FMS 301, for example, implemented at supervisor 200 shown in FIG. 2, to collect information from the AMR during the first predetermined route to produce a pattern language that may be used for modeling the material flow based on the information gathered in connection with the first predetermined route. The pattern language can be used to establish repeatable patterns of movement, i.e., a second and subsequent predetermined routes. The FMS and/or WMS, either one or both of which may be implemented on supervisory processor 200, can wirelessly communicate with all of the AMRs 100 and monitor their status, assign a next task, and/or instruct navigation or a non-work location. Accordingly, a system controlling the AMRs 100, for example, some or all of which may be implemented in a combination of the WMS/FMS 301 and AMRs 100, may operate according to a pattern language generated for modeling a material flow to accommodate the varying system requirements. The pattern language may be used for modeling the material flow to increase speed, allow for replicability, and reduce cost in delivering the material flow automation solution regardless of the unique indoor environment.

FIG. 4 is a flow diagram of a material flow automation process 20, in accordance with aspects of inventive concepts. An AMR 100 shown in FIGS. 1-3 may be programmed to travel along a predetermined route established by the process 20 and to perform operations of a material flow, for example, an indoor material flow. One example of an operation is where the AMR 100 places, or drops, objects on a pallet. Another example is where the AMR 100 picks an object from a pallet. The process 20 may include material flow 230, path plan 220, and information gathering 210 stages and in doing is constructed for generating a pattern language for establishing repeatable patterns of material flow. In some embodiments, one or more sensors 150, in particular, navigation cameras and pallet detection system sensors, are used for at least the information gathering stage 210.

As used herein, a pattern language describes a collection of templates of workflows for material movement. By creating a centralized collection of these templates, different material flow processes can be identified and executed using a predefined template rather than having to explain the detailed material flow steps each time. The templates may represent simplified real-world scenarios resulting from combining core elements, e.g., pick, drop, location, route in different combinations. The flow elements needed for a particular pattern or template can be derived directly from how the material is physically moved around in the facility. If a customer requires an AMR 100 to pick up an object at one location and drop it off at a different location, the details of this movement can be represented as material flow elements in the template.

In some embodiments, a pattern language is used to model a material flow in a simple manner so that an operator may ensure that his entries have been properly recorded by the system and that, as a result, his material flow jobs will be carried out as he envisions. The present inventive concept can refer to a given customer site as being an “X type of material flow site”. If the material flow in the site is novel and a process flow template, for example, used for robotic process automation or the like, has not yet been generated, then a new template can be created. A pattern language here can be a system for evaluating material flows and deriving common characteristics that are shared with other flows.

The process 20 can begin by the AMR 100 collecting data about a travel route from a current location to a new location. Here, the AMR 100 may not be preprogrammed and is configured to be expected to determine a route to the new location, for example, executing the dynamic route determination module 185. The decision diamonds 201, 205, 209 indicative of a known and unknown status can be applied to the core elements of the material flow, e.g., pick, drop, location, and travel route 201-209 of the path plan 220 and material flow 230 stages, respectively, and in doing so may allow the process 20 to identify one or more repeatable patterns of movement. As described herein, a repeatable pattern of movement may be identified based on the material flow elements, e.g., pick, drop, location, route by modeling the status of all four elements, for example, according to a parameter of a known and unknown status of the elements. The process 20 can distinguish known states from unknown states. For example, the process 20 recognizes when there is uncertainty as to where the material flow occurs, and also recognizes when a certainty about a path or destination is known upfront, prior to a motion of the AMR 100. It is well known that routes can be preprogrammed, for example, in cases where they are static and predefined. Here, if a robot route is static it is said to be known ahead of time. Here, the robot moves to the first location to pick up a pallet, the travels to a second location to drop off the pallet in a same manner.

However, as described above in other cases a route cannot be preprogrammed because the operator may require an AMR 100 to dynamically determine the route to an intended destination. Accordingly, the process 20 relies on a combination of known variables in advance as well as unknown variables which are determined as part of the process 20. In contrast to the static route mentioned in the previous example, if the AMR 100 route is configured to operation in a dynamic manner, the AMR 100 may pick a pallet from one of five different locations and drop it off at another location of the five locations. The exact route is not known in advance because there is multiple (i.e., 25) possible combinations of pick up and drop off locations and corresponding routes to be dynamically determined or selected by the operator. A pattern language may describe a collection of templates that are stored in a data repository so that different material flow scenarios can be determined using a predefined template, which represents a scenario resulting from the various combinations. For example, location 203 may be different from location 207 and not the same as required in a programmed AMR for the same static location. The particular combination that is selected may depend on the state of the material that needs to be moved in the facility, or other factors.

If the new location, e.g., location 207, is unknown, then the collected data can be processed to determine a travel route to the new location. At the new location, the AMR may perform a pick operation. The information about the pick can be collected, for example, by cameras and/or other sensors of the AMR 100 shown in FIG. 1, and provided to a system illustrated in FIG. 5, where it can be processed for planning a travel route. Modeling can be performed by a person evaluating a new site and is qualitative in nature. In doing so, the operator may inquire as to what kind of each of the core elements is happening and based on which and whether they are known or not, they match that to an existing pattern.

Thus, if an operator incorporates known and unknown information about the core elements for modeling, e.g., so that the core elements are matched to an existing pattern, the AMR knows how to get to every location that has been trained in the system. Thus, if an operator selects a location to send the AMR to, the robot can compute what paths to take to arrive there based on the trained path network it has in its memory. Although a location may not be unknown from the AMR's perspective with respect to being trained to arrive at the location. The location here is not known in advance with respect to the operator directing the AMR to the location for a given route in advance.

As described above, a pattern language comprising the core elements and key variables regarding the known and unknown status may be used to establish a plurality of repeatable patterns, for example, shown in FIG. 4 by the core elements of material flow, e.g., pick, drop, location, route, and a known/unknown status parameter on the core elements. As shown in FIG. 5, a software tool implanting and executing these features may be displayed on a user interface 320 allowing a user to use the collected information regarding the elements and patterns for the rapid articulation of a material flow that controls an automation system. These features also provided for an informed backend computing development and material flow modeling environment.

Referring again to FIG. 5, illustrated is a block diagram of a system for implementing patterns of material flow logic, in accordance with some embodiments. The system includes a material flow planning system 310, a user interface 320, and at least one AMR 330 or other mechanism that includes a computer processor or the like for executing instructions of the process of FIG. 3. The material flow planning system 310 may include an industrial controller 312 that communicates with the AMR 330 via an application programming interface (API) or the like to send instructions to the AMR 330 in response to the method of FIG. 4. For example, the controller 312 can send a signal that a path or location is determined according to a repeatable pattern of a material flow determined by a pattern language based on a combination of flow patterns determined from stored historical data and fundamental flow patterns based on public traffic systems or the like. The material flow planning system 310 may include a first input for receiving a plurality of core material flow elements, for example, from the WMS/FMS, AMS, and/or computer server and second input for receiving a parameter that includes a status of each of the core material flow elements, for example, from the WMS/FMS, AMS, and/or computer server. The first and second inputs can receive commands, information, etc. from the user interface 320. The computer server may execute some or all of the process steps of FIG. 4 and may reside in a cloud computing environment or in the indoor operation.

Repeatable patterns of movement can be identified by combining the core elements of material flow, e.g., pick, drop, location, route) and a known/unknown status parameter on the core elements, for example, a status indicating that there is uncertainty regarding a path plan or destination where a pick or drop operation is desired. The material flow planning system 310 can use this data to increase the speed of the AMR 330 and allow replicability of the movement of the AMR 330 and/or other apparatuses in the material flow.

The foregoing can be illustrated by way of the following example. A database table may be generated and stored that contains all the composable material flow logic patterns for a material flow automation environment, for example, shown in FIG. 3. The table may be arranged to populate each row with a scenario name, each corresponding to a material flow scenario resulting from combining the core elements in different combinations. For each scenario name row, a plurality of columns may include relevant data. For example, a column for a scenario may include a description where the operator species the drop-off destination at a pickup area for an AMR and a column that include a path sequence, for example, a single pickup and a single drop-off, or multiple pickups and a single drop-off, and so on. The table may be presented from a graphical user interface (GUI) or other display that allows an operator to select various options, for example, whether the AMR has full route knowledge or is expected to dynamically determine a destination path. Another user-selectable field may include the vehicle type, i.e., a lift, tug, pallet jack, and so on. Another user-selectable field may include a material exchange method, i.e., fully autonomous, semi-autonomous, manual, and so on. These selections can be used to create new templates or modify existing templates, which in turn can be used for providing a repeatable pattern of a material flow determined by historical data and flow pattern data, even in cases where an AMR has not been to a particular location, and does not know in advance of a route to a location where an operator plans to send the AMR.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

Below follows an itemized list of statements describing embodiments in accordance with the inventive concepts:

1. A method for material flow automation process, comprising:
receiving a first input including a plurality of core material flow elements;
receiving a second input including a variable parameter that includes a status of each of the core material flow elements;
applying the parameter to the plurality of core material flow elements;
determining a plurality of composable material flow logic patterns from the application of the variable parameter to the plurality of core material flow elements; and
applying the composable material flow logic patterns for managing an automation of movement of a vehicle.

2. The method of statement 1, or any other statement or combinations of statements, wherein the core material flow elements include data regarding a pick, drop, location, and route of the vehicle.

3 The method of statement 1, or any other statement or combinations of statements, wherein the vehicle is an autonomous mobile robot (AMR).

4. The method of statement 1, or any other statement or combinations of statements, wherein the key variable includes a status of whether the core material flow elements are known or unknown.

5. The method statement 1, or any other statement or combinations of statements, wherein the core material flow elements and the variable parameter are arranged as a pattern language for determining the composable material flow logic patterns, and wherein the method further comprises modeling a material flow for repeatable patterns of movement by the vehicle according to the pattern language.

6. The method of statement 5, or any other statement or combinations of statements, wherein the pattern language is based on at least one indoor flow pattern of a factory or warehouse.

7. The method of statement 5, or any other statement or combinations of statements, wherein the pattern language includes a collection of workflow templates for material movement which are used for determining a material workflow based on one or more combinations of the core material flow elements.

8. The method of statement 1, or any other statement or combinations of statements, wherein applying the composable material flow logic patterns includes dynamically selecting one of a plurality of possible routes when a route is unknown, the one of the possible routes including a combination of the plurality of core material flow elements.

9. A computer readable medium having computer executable instructions for a material flow planning system that when executed by a processor performs the following steps comprising:
receiving at first input of the material flow planning system including a plurality of core material flow elements;
receiving a second input of the material flow planning system including a variable parameter that includes a status of each of the core material flow elements;
applying the parameter to the plurality of core material flow elements;
determining a plurality of composable material flow logic patterns from the application of the variable parameter to the plurality of core material flow elements; and
applying the composable material flow logic patterns for managing an automation of movement of a vehicle.

10. The computer readable medium of statement 9, or any other statement or combinations of statements, wherein the core material flow elements include data regarding a pick, drop, location, and route of the vehicle.

11. The computer readable medium of statement 9, or any other statement or combinations of statements, wherein the vehicle is an autonomous mobile robot (AMR).

12. The computer readable medium of statement 9, or any other statement or combinations of statements, wherein the key variable includes a status of whether the core material flow elements are known or unknown.

13. The computer readable medium of statement 9, or any other statement or combinations of statements, wherein the core material flow elements and the variable parameter are arranged as a pattern language for determining the composable material flow logic patterns, and wherein the method further comprises modeling a material flow for repeatable patterns of movement by the vehicle according to the pattern language.

14. The computer readable medium of statement 13, or any other statement or combinations of statements, wherein the pattern language is based on at least one indoor flow pattern of a factory or warehouse.

15. The computer readable medium of statement 13, or any other statement or combinations of statements, wherein the pattern language includes a collection of workflow templates for material movement which are used for determining a material workflow based on one or more combinations of the core material flow elements.

16. The computer readable medium of statement 9, or any other statement or combinations of statements, wherein applying the composable material flow logic patterns includes dynamically selecting one of a plurality of possible routes when a route is unknown, the one of the possible routes including a combination of the plurality of core material flow elements.

17. A computer program product executable by at least one processor to model a material flow using a pattern language, comprising:
four core material flow elements, including pick data, drop data, location data, and route data of a material flow machine; and
a variable parameter including a status of at least one of the four core material flow elements.

18. The computer program product of statement 17, or any other statement or combinations of statements, wherein the pattern language determines one or more composable material flow logic patterns, and a material flow for repeatable patterns of movement by a vehicle is determined according to the pattern language.

19. The computer program product of statement 17, or any other statement or combinations of statements, wherein the pattern language is based on at least one indoor flow pattern of a factory or warehouse.

20. The computer program product of statement 17, or any other statement or combinations of statements, wherein the pattern language includes a collection of workflow templates for material movement which are used for determining a material workflow based on one or more combinations of the core material flow elements.

What is claimed is:

1. A method for material flow automation process, comprising:
receiving a first input including a plurality of core material flow elements;
receiving a second input including a variable parameter that includes a status of each of the core material flow elements;
applying the parameter to the plurality of core material flow elements;
determining a plurality of composable material flow logic patterns from the application of the variable parameter to the plurality of core material flow elements; and
applying the composable material flow logic patterns for managing an automation of movement of a vehicle.

2. The method of claim 1, wherein the core material flow elements include data regarding a pick, drop, location, and route of the vehicle.

3. The method of claim 1, wherein the vehicle is an autonomous mobile robot (AMR).

4. The method of claim 1, wherein the key variable includes a status of whether the core material flow elements are known or unknown.

5. The method of claim 1, wherein the core material flow elements and the variable parameter are arranged as a pattern language for determining the composable material flow logic patterns, and wherein the method further comprises:
modeling a material flow for repeatable patterns of movement by the vehicle according to the pattern language.

6. The method of claim 5, wherein the pattern language is based on at least one indoor flow pattern of a factory or warehouse.

7. The method of claim 5, wherein the pattern language includes a collection of workflow templates for material movement which are used for determining a material workflow based on one or more combinations of the core material flow elements.

8. The method of claim 1, wherein applying the composable material flow logic patterns includes dynamically selecting one of a plurality of possible routes when a route is unknown, the one of the possible routes including a combination of the plurality of core material flow elements.

9. A computer readable medium having computer executable instructions for a material flow planning system that when executed by a processor performs the following steps comprising:
receiving at first input of the material flow planning system including a plurality of core material flow elements;
receiving a second input of the material flow planning system including a variable parameter that includes a status of each of the core material flow elements;
applying the parameter to the plurality of core material flow elements;
determining a plurality of composable material flow logic patterns from the application of the variable parameter to the plurality of core material flow elements; and
applying the composable material flow logic patterns for managing an automation of movement of a vehicle.

10. The computer readable medium of claim 9, wherein the core material flow elements include data regarding a pick, drop, location, and route of the vehicle.

11. The computer readable medium of claim 9, wherein the vehicle is an autonomous mobile robot (AMR).

12. The computer readable medium of claim 9, wherein the key variable includes a status of whether the core material flow elements are known or unknown.

13. The computer readable medium of claim 9, wherein the core material flow elements and the variable parameter are arranged as a pattern language for determining the composable material flow logic patterns, and wherein the method further comprises:
modeling a material flow for repeatable patterns of movement by the vehicle according to the pattern language.

14. The computer readable medium of claim 13, wherein the pattern language is based on at least one indoor flow pattern of a factory or warehouse.

15. The computer readable medium of claim 13, wherein the pattern language includes a collection of workflow templates for material movement which are used for determining a material workflow based on one or more combinations of the core material flow elements.

16. The computer readable medium of claim 9, wherein applying the composable material flow logic patterns includes dynamically selecting one of a plurality of possible routes when a route is unknown, the one of the possible routes including a combination of the plurality of core material flow elements.

17. A computer program product executable by at least one processor to model a material flow using a pattern language, comprising:
four core material flow elements, including pick data, drop data, location data, and route data of a material flow machine; and
a variable parameter including a status of at least one of the four core material flow elements.

18. The computer program product of claim 17, wherein the pattern language determines one or more composable material flow logic patterns, and a material flow for repeatable patterns of movement by a vehicle is determined according to the pattern language.

19. The computer program product of claim 17, wherein the pattern language is based on at least one indoor flow pattern of a factory or warehouse.

20. The computer program product of claim 17, wherein the pattern language includes a collection of workflow templates for material movement which are used for determining a material workflow based on one or more combinations of the core material flow elements.
